(19) United States
(12) Patent Application Publication
(10) Pub. No.: US 2026/0192925 A1
(43) Pub. Date: Jul. 9, 2026

(54) ARMREST LOCKING SYSTEM

(71) Applicant: Tusas- Turk Havacilik Ve Uzay Sanayii Anonim Sirketi, Kahramankazan, Ankara (TR)

(72) Inventors: Ahmet Hakan BOZKURT, Kahramankazan, Ankara (TR); Hasan AKMAN, Kahramankazan, Ankara (TR); Ali AKCAY, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/133,792

(22) PCT Filed: Oct. 27, 2023
(86) PCT No.: PCT/TR2023/051212

§ 371 Date: May 29, 2025

(30) Foreign Application Priority Data
Nov. 29, 2022 (TR) 2022/018144

(51) Int. Cl. B64D 11/06; B64C 13/04; F16H 37/12

(52) U.S. Cl. CPC B64D 11/0689; B64C 13/0421; B64D 11/0644; F16H 37/12

(57) ABSTRACT

The present invention relates to a joystick (J) on an air vehicle used by a pilot to steer the air vehicle; at least one armrest (K) on the air vehicle, on which the pilot places his hand to use the joystick (J) in an ergonomic way; a body (2) on the air vehicle; a first rotary arm (3) connected to the body (2) and rotated around an axis to which it is attached, so as to change a position of the armrest (K); at least one armrest screw (4) located in the form of multiple recesses on the armrest (K) at a distance predetermined by the user, thus allowing the height adjustment of the armrest (K); at least one height stabilizer (5) which at least partially contacts the armrest screw (4) to fix the armrest (K) at a desired height; a first position (I) in which a distance is provided between the height stabilizer (5) and the armrest screw (4), allowing the height adjustment of the armrest (K); a second position (II) in which the height stabilizer (5) at least partially contacts the armrest screw (4) to fix the height of the armrest (K); a latch (6) that allows the height stabilizer (5) to be moved to the first position (I) or second position (II) by the user; a spring (7) which is compressed in the first position (I) and the second position (II), and which moves to the second position (II) when the user releases the latch (6) in the first position (I), thus enabling the height stabilizer (5) to move from the first position (I) to the second position (II) and fixing the height of the armrest (K).

### FIELD AND BACKGROUND OF THE INVENTION

This invention relates to a locking system for an armrest required by a pilot when using a joystick in air and/or space vehicles.

Pilots put their arms on the armrest while using the joystick in air and/or space vehicles. The armrest is used to provide an ergonomic use for the pilot while using the joystick, which provides control input to the air and/or space vehicle. The armrest mechanism is used to prevent the pilot from transferring uncontrolled power or to help the pilot transfer a required power even in case of exhausted. In some combat aircraft, the joystick is placed on a side panel in the cockpit, and all aircraft with a side joystick use the armrest mechanism. The pilot places his/her arm on the armrest to provide a more comfortable and precise force transfer while providing input to the joystick, without carrying the weight of his/her own arm, especially during long flight periods. Therefore, the pilot can provide more precise force transfer to the joystick. Potential improvements in armrests, especially the design of adjustable armrest systems in next generation combat aircraft, provide significant advantages for pilots in the battlefield. Considering that the pilots using the armrest mechanism would have a wide range of sizes and weights, both position and height of the armrest must be adjustable in order to be used by different pilots. The required armrest position range is determined in the flight direction depending on the length of the pilot's forearm, and the armrest height adjustment is determined in the vertical direction depending on the pilot's shoulder height. Following said adjustments, the system must be locked securely.

KR102047770, which is included in the known-state of the art, discloses a simply adjustable armrest with a pad attachment and a pad part, which has a predetermined length for the user to place their arm. A movable part has a plurality of locking jaws formed on an outer peripheral surface thereof. There is a fixing part to fix the upward and downward movement of the movable part. It engages the same shaped surface facing a pair of outer surfaces of the movable part to guide the separation of the guide part and the fixing part and to limit the movement of the fixing part. The fixing part comprises a support with a fixed end. The system comprises a pin to adjust the armrest height; a spring surrounding the pin with one end connected to the fixed body and the other end to the pin protrusion; and a latch connected to the spring. The user pulls the spring to the right to compress the spring and adjust the armrest height, and following the armrest height adjustment, releases the latch to extend the spring and insert the pin protrusion into the armrest recess, so that the armrest is fixed at its current height and armrest height lock is provided. Armrest position adjustment is performed by rotating the armrest around a point to which it is rotatably attached.

KR101925112, which is included in the known-state of the art, discloses an adjustable armrest system for use in fighter jets. While using the joystick, the pilot can adjust a height and angle of the armrest system with one hand. When the armrest is not required to be used, it can simply be folded. In order to adjust the armrest height, there is a pin; a spring surrounding the pin with one end connected to the fixed body and the other end connected to the pin protrusion; and a latch connected to the spring. There is a latch attached to the spring, the user pulls the body to the right to compress the spring, such that the pin is removed from the armrest recess and the armrest height is adjusted, and following the armrest height adjustment, when the body is released, the spring extends and the pin protrusion enters the armrest recess, so that the armrest is fixed at its current height, providing the armrest height lock. Armrest position adjustment is performed by rotating and folding the armrest around a point to which it is rotatably attached.

U.S. Pat. No. 4,244,623, which is included in the known-state of the art, discloses a multi-position armrest system. In the system, armrest position locking is provided by a system similar to a ratchet mechanism. The rods form a parallelogram. An upper end of the connecting rod member comprises a gear section having gears at its leading edge and trailing edge. An upper ratchet is used to lock the rotation adjustment position of the armrest relative to the pivot shaft. The ratchet is rigidly mounted on a pivot shaft supported by the support bracket. Additionally, the upper end of a tension spring is attached to an arm rigidly mounted on the pivot shaft for synchronous movement with the ratchet. The lower end of the spring is attached to a bracket. The purpose of the spring is to flexibly press the tab to engage the gears to prevent the armrest from tilting downward, while allowing the tab to pass over the gears when the front end of the armrest is lifted. To move the armrest down, a button mounted on the front end of a reclining arm must be pressed.

US2022363396A1, discloses a cockpit-center console arm-rest assembly designed for business or general-aviation aircraft in which the arm-rest can both telescope vertically and swing laterally out of the pilot's way: a floor-mounted base supports an extending column formed by an outer tube and a height-adjustable inner tube that lock together via a lever-actuated release mechanism hidden on the underside of the arm-rest; squeezing the lever disengages the lock so the pilot can slide the inner tube to the desired height, whereupon releasing the lever re-secures the tubes; the column is also hinged to the base about a pivot axis so the entire arm-rest can rotate between a deployed, in-use position next to the pilot's seat and a stowed, retracted position flush with the console, thereby saving space during ingress, egress, or combatting ergonomic interference while still giving the pilot a quickly adjustable support point when needed.

### SUMMARY OF THE INVENTION

Thanks to an armrest locking system according to the present invention, the armrest systems adjustable both in position and height can be locked securely.

Another object of the present invention is to enable both position adjustment and height adjustment in armrest systems via a single latch.

Another object of the present invention is to ensure that the armrest systems adjustable both in position and height can be locked ergonomically, easily and quickly by the pilot.

A further object of the present invention is to automatically lock both position and height after position and height adjustments are performed independently in armrest systems that adjustable both in position and height.

The armrest locking system realized to achieve the object of the invention, which is defined in the first claim and other claims dependent thereon, comprises an armrest for a pilot to place his arm; and a joystick for the pilot to control the air vehicle. A first rotary arm is rotatably connected to the body so as to rotate around an axis on which it can rotate freely, thus enabling the pilot to adjust the mechanical location or position of the armrest and all movements in which the armrest can move in three-dimensional space, except the armrest height adjustment. Mechanical location and position mean the entire range of movement that the armrest can move in three-dimensional space, other than the armrest height adjustment. In order to adjust the armrest height, armrest screws are provided in the form of multiple grooves located at certain intervals on the armrest. There is a height stabilizer that enters and contacts the armrest screw and allows the armrest to be positioned at a desired height. There is a first position (I), in which the height stabilizer does not contact the armrest screw, allowing armrest height adjustment, and a second position (II), in which the height stabilizer enters the armrest screw and the armrest height is fixed at the current height. The latch allows the user to move the height stabilizer to the first position (I) or the second position (II). The spring is in compressed state in the first position (I) and the second position (II). The spring is extended in a third position (III) compared to the first position (I) and the second position (II). The spring can preferably be preloaded. After the user releases the latch in the first position (I) or second position (II), the latch and spring automatically move to the third position (III). In this way, the height stabilizer moves from the first position (I) to the third position (III) and the armrest height is fixed at a height determined or set by the pilot. In addition, the mechanism stabilizer is moved from the second position (II) to the third position (III) and the armrest mechanical position is fixed in the current position. In an alternative embodiment of the invention wherein one end of the spring is connected to the height stabilizer and the other end is connected to the fixed body, the armrest height can be adjusted.

The armrest locking system according to the invention comprises a mechanism fixing gear located on the body and having a plurality of recesses in the form of a groove. The mechanism fixing gear is in a gear form. There is a mechanism stabilizer that can be moved in and out of the mechanism fixing gear and enables the armrest position to be fixed. In the first position (I), the mechanism fixing mechanism contacts at least partially with the fixing gear, enabling the armrest position to be locked and fixed. In the second position (II), the mechanism fixing mechanism does not contact the fixing gear in any way with a gap therebetween, allowing the armrest position to change freely. One end of the spring is connected to the height stabilizer, and the other end to the mechanism stabilizer. Depending on the force exposed, a latch is provided on the latch plate, which is in the form of a plate, sheet metal or a three-dimensional solid object as determined by the manufacturer. There are at least two latch channels in the latch plate, which are provided as openings. The height stabilizer and the mechanism stabilizer each move within their own latch channel opening. Each end of the height stabilizer and the mechanism stabilizer moves within its own latch channel opening. The height stabilizer can only contact an end of the latch channel opening that is towards the armrest. In the second (II) and third position (III) in which the height stabilizer contacts the armrest screw, the height stabilizer remains fixed, and the latch channel, in which it is moving, moves and changes position by moving the latch. The mechanism stabilizer can only contact a surface of the inner wall of latch channel that is towards the mechanism fixing gear. The height stabilizer is positioned close to an end of the latch channel on the armrest, and the mechanism stabilizer is positioned close to an end of the latch channel on the mechanism fixing gear, wherein in the first position (I), only the mechanism stabilizer contacts the closest end, and in the second position (II), only the height stabilizer contacts the closest end. The height stabilizer in the first position (I) and the mechanism stabilizer in the second position (II) move freely within their latch channel, without contacting end parts of the inner wall in the latch channel. Thus, the height stabilizer and the mechanism stabilizer can move independently of each other. While one end of the spring is connected to the height stabilizer, the other end is connected to the mechanism stabilizer. Thus, both armrest height adjustment and armrest position adjustment can be performed by a single latch.

In an embodiment of the invention, the armrest locking system can be moved to the third position (III). In the third position (III), the pilot takes his/her hand off the latch while the latch is in the first position (I) or second position (II), then the height stabilizer engages the armrest screw, enabling the armrest to be fixed at a desired height while at the same time enabling the mechanism stabilizer to engage the mechanism fixing gear to fix the armrest position. The spring enables the pilot to move the armrest directly from the first position (I) or second position (II) to the third position (III) without applying any extra force. In the first and third positions (III) in which the mechanism stabilizer contacts the mechanism fixing gear, the mechanism stabilizer remains fixed, and the latch channel, in which it is moving, moves and changes position by moving the latch.

In an embodiment of the invention, in the first position (I) of the armrest locking system, the mechanism stabilizer engages the mechanism fixing gear, and an end of the spring connected to the mechanism fixing gear is fixed. In the second position (II), the height stabilizer engages the armrest screw, and an end of the spring connected to the height stabilizer is fixed. In the third position (III), the mechanism stabilizer is locked by engaging the mechanism fixing gear, and additionally, the height stabilizer is locked by engaging the armrest screw. Thus, the armrest automatically moves to the third position (III) by releasing the latch in the first position (I) or second position (II).

In an embodiment of the invention, the armrest locking system comprises an armrest pin. The armrest pin is located on the height stabilizer in the form of an extension extending perpendicular to a direction along which the height stabilizer extends longitudinally. The armrest locking system comprises a locking pin. The locking pin is located between the spring and the mechanism stabilizer, with one end in contact with the spring and passing through the latch channel. The armrest pin contacts an end of the latch channel on the armrest side, and the locking pin contacts on end of the latch channel on the mechanism fixing gear side, thereby transferring the latch movement to the height stabilizer and the mechanism stabilizer.

In an embodiment of the invention, the armrest locking system comprises a second rotary arm. The second rotary arm is connected to the body, rotates freely around an axis to which it is connected, and forms a four-bar mechanism with the body and the first rotary arm. The armrest locking system comprises an armrest arm. The armrest arm is connected to the first rotary arm and the second rotary arm such that they can rotate around their own axes. There is an armrest on the armrest arm that passes through the armrest arm. The armrest arm, in the form of a housing, contains the armrest and lock systems. The armrest locking system comprises a transmission arm. One end of the transmission arm is connected to the mechanism stabilizer, and the other end is connected to the height stabilizer, with the possibility of other components provided in between. The transmission arm passes through the latch channel, thus enabling position changes of the latch between the first position (I) and the second position (II) to be transferred to the mechanism stabilizer by contacting the inner wall of the latch channel.

In an embodiment of the invention, the armrest locking system comprises latch channel. In an alternative embodiment of the invention, the latch channel, height stabilizer and mechanism stabilizer are telescopically connected to each other. The telescopic connection can preferably be form-compatible. Thanks to the telescopic connection type, the telescopic connection can perform function of the latch channel.

In an embodiment of the invention, the armrest locking system comprises mechanism fixing gear. The mechanism fixing gear is located at an end of the second rotary arm rotatably connected to the armrest arm, and almost completely surrounds the end of the second rotary arm connected to the armrest arm in a radial and circumferential manner, wherein the mechanism fixing gear is provided as a gear with consecutive recesses and protrusions.

In an embodiment of the invention, the armrest locking system comprises armrest screw. The armrest screw is located at a handle portion of the armrest, from the end of the armrest connected to the armrest arm towards the armrest, with groove-shaped recesses in the form of a recess, at intervals determined by the user. This allows the height adjustment of the armrest. One end of the height stabilizer is connected to the armrest screw and the other end is connected to the spring and passes through the latch channel. Thus, the height stabilizer enables the current height of the armrest to be fixed by transferring the position changes of the latch between the first position (I) and the second position (II) by contacting the inner wall of the latch channel. The height stabilizer does not contact the armrest screw in the first position, while contacting in the second and third positions. The height stabilizer contacts the spring in the first position, second position and third position.

In an embodiment of the invention, the armrest locking system comprises a height stopper. The height stopper is located to form an extension on the armrest screw recess that is furthest from the armrest and closest to the floor. There is a protrusion form-compatible with the height stopper, at an end of the height stabilizer that contacts the height stopper. By engaging the height stopper into the recess of the height stabilizer, the armrest height is limited and the armrest is locked, so that the armrest is prevented from falling towards the floor.

In an embodiment of the invention, the armrest locking system comprises an angle locker. The armrest is rotated by the pilot at a desired angle around an axis extending from the armrest to the armrest handle longitudinally. Then, the angle locker is rotated clockwise around an axis where it is attached to the armrest, and the angle locker compresses outer wall of the armrest and applies friction force to the armrest, thereby fixing the armrest at its current angle as it is rotated around its own axis.

In an embodiment of the invention, the armrest locking system comprises the armrest. A knurling outer surface is provided on a surface of the armrest that contacts the angle locker, thus contributing to increasing friction.

In an embodiment of the invention, the armrest locking system comprises the armrest screw. The armrest screw in the form of a recess and the protrusions located successively form a ratchet tooth form. The armrest screw in the form of a recess and the protrusions located successively are preferably geometrically compatible with each other. Armrest screws with different recess forms and different protrusion forms can be selected according to user preferences and requirements. In case the height stabilizer contacts the armrest protrusion parts, which are located sequentially with the armrest screw, the rachet tooth allows the height stabilizer to engage the next armrest screw only in the downward direction, thus allowing armrest height adjustment in only one direction.

In an embodiment of the invention, the armrest locking system comprises the first rotary arm, second rotary arm and armrest arm. The body, first rotary arm, second rotary arm and armrest arm are rotatably connected to each other using castle nut and cotter pin fasteners.

### BRIEF DESCRIPTION OF THE SEVERAL VIEWS OF THE DRAWING(S)

The armrest locking system realized to achieve the object of the invention is illustrated in the attached drawings, in which:

FIG. 1 is a top view of an armrest locking system.

FIG. 2 is a perspective view of an alternative embodiment of an armrest locking system without a second rotary arm.

FIG. 3 is a schematic view of an alternative telescopic embodiment of the invention.

FIG. 4 is a perspective view of an armrest locking system.

FIG. 5 is a perspective view of the armrest locking system in the third position (III).

FIG. 6 is a top view of the transmission arm, mechanism fixing gear and mechanism stabilizer in the first position (I) and third position (III).

FIG. 7 is a top view of the transmission arm, mechanism fixing gear and mechanism stabilizer in the second position (II).

FIG. 8 is a perspective view of the transmission arm, armrest screw, height stabilizer, armrest pin, locking pin and spring in the first position (I).

FIG. 9 is a perspective view of the transmission arm, armrest screw, height stabilizer, armrest pin, locking pin and spring in the second position (II).

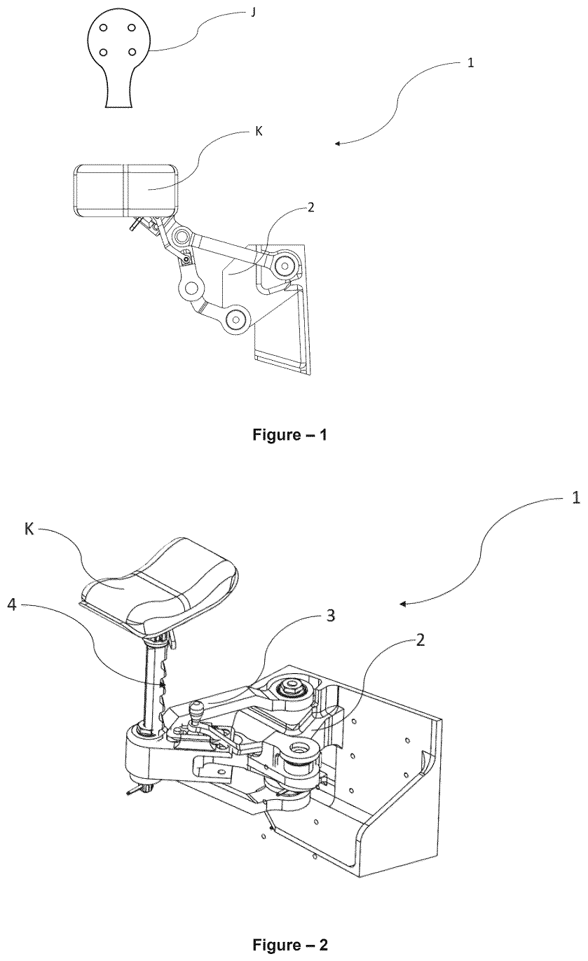

### DESCRIPTION OF SPECIFIC EMBODIMENTS OF THE INVENTION

All the parts illustrated in figures are individually assigned a reference numeral and the corresponding terms of these numbers are listed below:
1. Armrest locking system
2. Body
3. First rotary arm
4. Armrest screw
5. Height stabilizer
6. Latch
7. Spring
8. Mechanism fixing gear
9. Mechanism stabilizer
10. Latch plate
11. Latch channel
12. Armrest pin
13. Locking pin
14. Second rotary arm
15. Armrest arm
16. Transmission arm
17. Height stopper
18. Angle locker
(J) Joystick
(K) Armrest
(I) First position
(II) Second position
(III) Third position

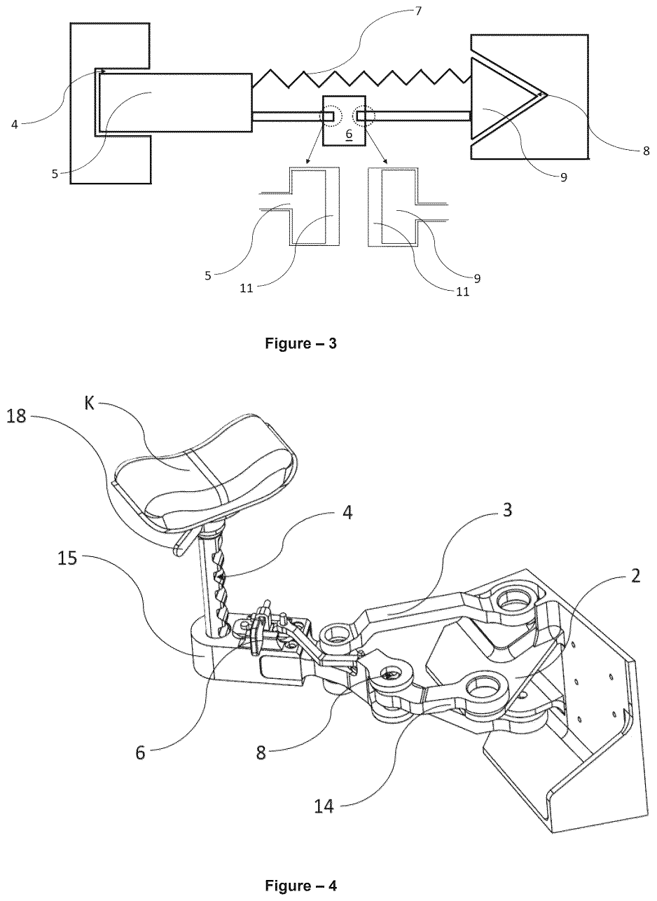

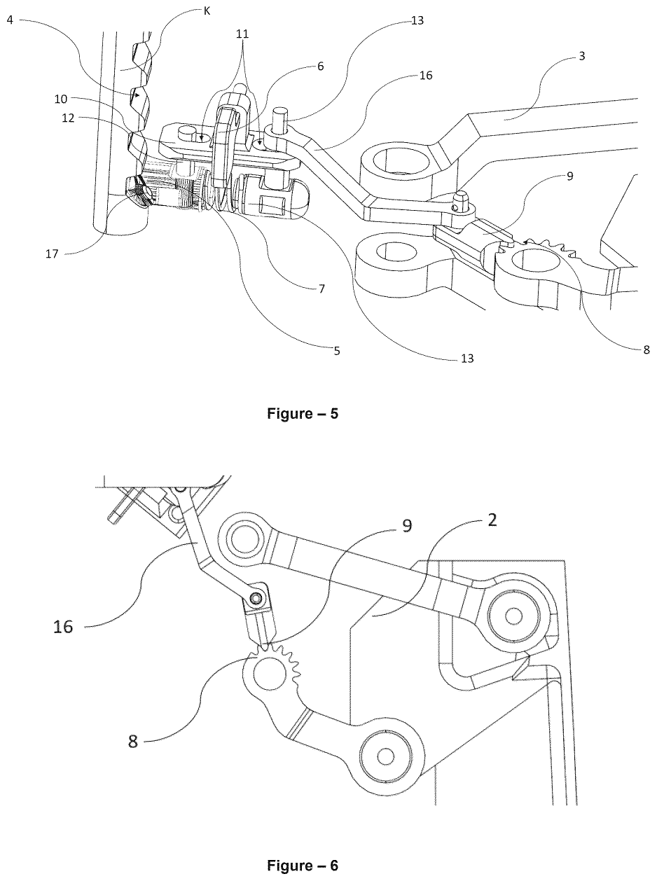

The armrest locking system (1) comprises a joystick (J) on an air vehicle used by a pilot to steer the air vehicle; at least one armrest (K) on the air vehicle, on which the pilot places his hand to use the joystick (J) in an ergonomic way; a body (2) on the air vehicle; a first rotary arm (3) connected to the body (2) and rotated around an axis to which it is attached, so as to change a position of the armrest (K); at least one armrest screw (4) located in the form of multiple recesses on the armrest (K) at a distance predetermined by the user, thus allowing the height adjustment of the armrest (K); at least one height stabilizer (5) which at least partially contacts the armrest screw (4) to fix the armrest (K) at a desired height; a first position (I) in which a distance is provided between the height stabilizer (5) and the armrest screw (4), allowing the height adjustment of the armrest (K); a second position (II) in which the height stabilizer (5) at least partially contacts the armrest screw (4) to fix the height of the armrest (K); a latch (6) that allows the height stabilizer (5) to be moved to the first position (I) or second position (II) by the user; a spring (7) which is compressed in the first position (I) and the second position (II), and which moves to the second position (II) when the user releases the latch (6) in the first position (I), thus enabling the height stabilizer (5) to move from the first position (I) to the second position (II) and fixing the height of the armrest (K) (FIG. 2, FIG. 5).

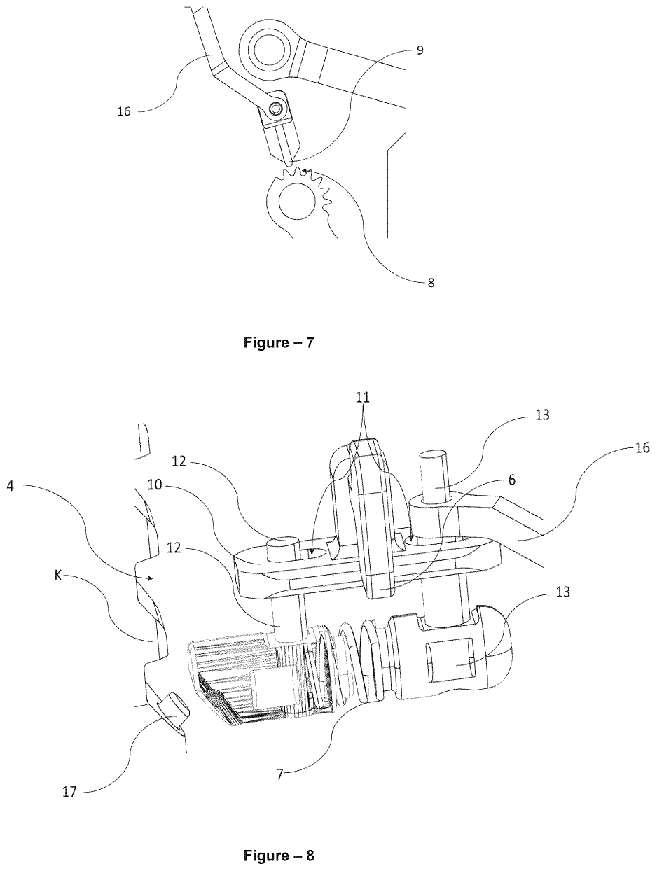

The armrest locking system (1) according to the invention comprises a mechanism fixing gear (8) located on the body (2) and having multiple groove-shaped recesses; a mechanism stabilizer (9) which removably engages the mechanism fixing gear (8) to fix position of the armrest (K); the first position (I) in which the mechanism stabilizer (9) at least partially contacts the mechanism fixing gear (8) to fix position of the armrest (K); the second position (II) in which a distance is provided between the mechanism stabilizer (9) and the mechanism fixing gear (8) such that position of the armrest (K) is changed freely; the spring (7), with one end connected to the height stabilizer (5) and the other end to the mechanism stabilizer (9); a latch plate (10) on which the latch (6) is located; a latch channel (11) located as at least two openings on the latch plate (10); the latch (6) that allows the height stabilizer (5) and the mechanism stabilizer (9) to move independently of each other within the latch channel (11), such that the height stabilizer (5) and mechanism stabilizer (9) each move within one latch channel (11) opening and only one of the height stabilizer (5) and the mechanism stabilizer (9) moves together with the latch (6) by contacting the inner wall of the latch channel (11), with the other having a distance to the latch channel (11) opening. A mechanism fixing gear (8), which is located on the body (2) with multiple groove-shaped recesses, is preferably in the form of a gear with 16 teeth. The module number of the mechanism fixing gear (8) is 1 (FIG. 2, FIG. 3, FIG. 5, FIG. 6).

The armrest locking system (1) comprises the armrest (K) for the pilot to place his arm; and the joystick (J) for the pilot to control the air vehicle. The first rotary arm (3) is connected to the body (2) and rotates around the axis to which it is attached, allowing the pilot to adjust position of the armrest (K). In order to adjust height of the armrest (K), there is an armrest screw (4) in the form of multiple recesses located at certain intervals on the armrest (K). There is a height stabilizer (5) that engages the armrest screw (4) to contact at least partially thereto, thereby enabling the armrest (K) to be fixed at its current height. There is a first position (I) in which a distance is provided between the height stabilizer (5) and the armrest screw (4), allowing height adjustment of the armrest (K); a second position (II) in which the height stabilizer (5) at least partially contacts the armrest screw (4) to fix the armrest (K) height. The latch (6) allows the height stabilizer (5) to be moved to the first position (I) or second position (II) by the user. The spring (7) is compressed in the first position (I) and extended in the second position (II). The user releases the latch (6) in the first position (I) and the latch (6) moves to the second position (II). Therefore, the height stabilizer (5) moves from the first position (I) to the second position (II), so that the height of the armrest (K) is fixed. One end of the spring (7) is connected to the height stabilizer (5) (FIG. 3, FIG. 5).

The mechanism fixing gear (8) is located on the body (2) with multiple groove-shaped recesses thereon. The mechanism stabilizer (9) removably engages the mechanism fixing gear (8) and ensures fixation of position of the armrest (K). In addition to the height locking of the armrest (K) in the first position (I) and second position (II), position locking is also provided. In the first position (I), the mechanism stabilizer (9) at least partially contacts the mechanism fixing gear (8) to fix the armrest (K) position, while in the second position (II), the mechanism stabilizer (9) has a distance to the mechanism fixing gear (8), allowing the armrest (K) position to change freely. The latch (6) is located on the latch plate (10). There is a latch channel (11) located as at least two openings on the latch plate (10), and the latch channel (11) extends along the direction in which the latch plate (10) extends, at a distance predetermined by the user. Each of the height stabilizer (5) and the mechanism stabilizer (9) moves only in their dedicated latch channel (11) opening. While only one of the height stabilizers (5) and the mechanism stabilizer (9) contacts the inner wall of the latch channel (11) at the same time and moves together with the latch channel (11), the other one remains fixed by keeping a distance from the end of the latch channel (11) opening. Since the latch plate (10) contact the inner wall at the two ends of the latch channel (11) opening along the direction in which the latch plate (10) extends, the latch channel (11) and the height stabilizer (5) or the latch channel (11) and the mechanism stabilizer (9) can be moved together or within each other. In this way, height stabilizer (5) and mechanism stabilizer (9) can move independently of each other within the latch channel (11) openings, and the user can only fix the armrest (K) height or lock the armrest (K) position at the same time via a single latch (6) (FIG. 5, FIG. 6).

In an embodiment of the invention, the armrest locking system (1) comprises a third position (III) in which the latch (6) is released in the first position (I) or in the second position (II) such that the height stabilizer (5) at least partially contacts the armrest screw (4) to fix the armrest (K) at a desired height, and in which the mechanism stabilizer (9) at least partially contacts the mechanism fixing gear (8) to fix position of the armrest (K); the spring (7) that allows the armrest (K) to be moved from the first position (I) or second position (II) to the third position (III) by releasing the latch (6) by the user. The spring (7) extends by releasing the latch (6) in the first position (I) or the second position (II). Thus, both the height lock and the position lock of the armrest (K) in the third position (III) are provided by the pilot simply releasing the latch (6) without having to apply any additional force to the latch (6) (FIG. 5).

In an embodiment of the invention, the armrest locking system (1) comprises the armrest (K), wherein in the first position (I) the mechanism stabilizer (9) almost completely contacts the mechanism fixing gear (8) to fix an end of the spring (7) connected to the mechanism fixing gear (8), in the second position (II) the height stabilizer (5) almost completely contacts the armrest screw (4) to fix an end of the spring (7) connected to the height stabilizer (5), in the third position (III) both the mechanism stabilizer (9) almost completely contacts the mechanism fixing gear (8) and the height stabilizer (5) is locked by almost completely contacting the armrest screw (4), so that when the latch (6) is released in the first position (I) or the second position (II), the armrest (K) is moved to the third position (III). In the first position (I), since the mechanism stabilizer (9) remains fixed in the locked position by contacting the mechanism fixing gear (8), the end of the spring (7) connected to the mechanism stabilizer (9) is fixed, and thus, only the end of the spring (7) connected to the height stabilizer (5) moves, so that the height of the armrest (K) can be changed and the armrest (K) can be locked positionally. Similarly, in the second position (II), since the height stabilizer (5) remains fixed by contacting the armrest screw (4), the end of the spring (7) connected to the height stabilizer (5) is fixed, and thus, only the end of the spring (7) connected to the mechanism stabilizer (9) moves, allowing the position of the armrest (K) to be changed and the height of the armrest (K) to be fixed. (FIG. 5).

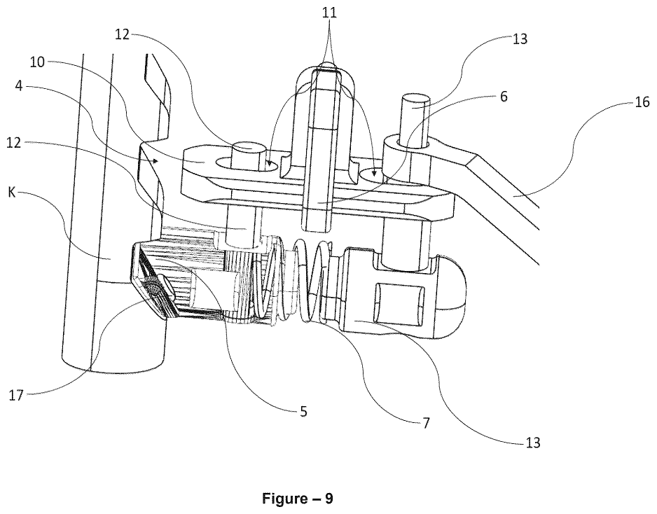

In an embodiment of the invention, the armrest locking system (1) comprises at least one armrest pin (12) located on the height stabilizer (5) as a protrusion extending perpendicular to the direction along which the height stabilizer (5) extends longitudinally; at least one locking pin (13) located between the spring (7) and the mechanism stabilizer (9) and passing through the latch channel (11), with one end in contact with the spring (7); the latch (6) that allows independent movement at the inner wall of the latch channel (11) due to the armrest pin (12) and locking pin (13) being in almost complete contact with the inner walls of the latch channel (11). The latch channel (11) enables the height stabilizer (5) to move via the armrest pin (12) and also provides centering and alignment functions. Similarly, the latch channel (11) enables the movement of the mechanism stabilizer (9) via the locking pin (13), and also provides centering and alignment functions (FIG. 5, FIG. 8, FIG. 9).

In an embodiment of the invention, the armrest locking system (1) comprises a second rotary arm (14) which is connected to the body (2), rotated around the axis to which it is connected, and forms a four-bar mechanism with the body (2) and the first rotary arm (3); an armrest arm (15) with the armrest (K) thereon, which is connected to the first rotary arm (3) and the second rotary arm (14) and rotates around the axis to which it is connected; at least one transmission arm (16), with one end connected to the mechanism stabilizer (9) and the other end to the locking pin (13), wherein the transmission arm (16) passes through the latch channel (11) and enables position changes of the latch (6) between the first position (I) and the second position (II) to be transferred to the mechanism stabilizer (9) by contacting the inner wall of the latch channel (11). By using the second rotary arm (14), armrest arm (15) and transmission arm (16), the armrest locking system (1) can also be used in armrest (K) systems with four arm mechanisms, while positioning the armrest (K) over a wide range of movements (FIG. 4).

In an embodiment of the invention, the armrest locking system (1) comprises the latch channel (11) telescopically connected to height stabilizer (5) and mechanism stabilizer (9). The height stabilizer (5) and the mechanism stabilizer (9) can move freely within the latch channel (11) and can move together when their walls contact each other. Latch channel (11) is geometrically compatible with the height stabilizer (5) and the mechanism stabilizer (9). The height stabilizer (5) and the mechanism stabilizer (9) have parts that are inserted and removed from the latch channel (11). The latch (6) is located between the height stabilizer (5) and the mechanism stabilizer (9). It comprises the height stabilizer (5) enables the current height of the armrest (K) to be fixed by transferring the position changes of the latch (6) between the first position (I) and the second position (II) when it contacts the inner wall of the latch channel (11). While the pilot pulls the latch (6) towards the mechanism fixing gear (8) to bring it to the first position (I), the height stabilizer (5) contacts the inner wall of the latch channel (11), located on the side of the armrest screw (4), thus allowing the latch (6) and the armrest screw (4) to change position together. The space provided by the telescopic connection between the inner wall of the latch channel (11) and the height stabilizer (5) and the mechanism fixing gear (8) enables the height stabilizer (5) and the mechanism fixing gear (8) to move independently of each other. The spring (7) is located between the height stabilizer (5) and the mechanism fixing gear (8). One end of the spring (7) is directly connected to the height stabilizer (5), and the other end is directly connected to the mechanism fixing gear (8). The spring (7) and the latch (6) are connected parallel to each other, not end to end, and do not directly affect each other (FIG. 3).

In an embodiment of the invention, the armrest locking system (1) comprises the mechanism fixing gear (8) in a gear form with successive recesses and protrusions, which is located at an end of the second rotary arm (14) connected to the armrest arm (15), so as to almost completely surround the end of the second rotary arm (14) connected to the armrest arm (15). Since the mechanism fixing gear (8) with successive recesses and protrusions almost completely surrounds the end of the second rotary arm (14) connected to the armrest arm (15), and since the second rotary arm (14) is connected rotatably to the body (2), when the armrest (K) positions change, the armrest (K) position is locked by means of the mechanism stabilizer (9) engaging the mechanism fixing gear (8) in a centered and aligned manner. Due to the fact that the mechanism fixing gear (8) is provided with successive recesses and protrusions and almost completely surrounds the end of the second rotary arm (14) connected to the armrest arm (15), and that it contacts the mechanism fixing gear (8) corresponding to the gear suitable for various positions of the armrest (K), the user is allowed to lock the armrest (K) in the desired mechanical position. In all positions of the armrest (K), it is ensured that the mechanism stabilizer (9) and at least one recess of the mechanism fixing gear (8) are almost completely opposite and aligned (FIG. 6, FIG. 7).

In an embodiment of the invention, the armrest locking system (1) comprises the armrest screw (4) with groove-shaped recesses, which is located at intervals determined by the user, from the end of the armrest (K) connected to the armrest arm (15), towards the armrest (K), wherein the armrest screw (4) allows height adjustment of the armrest (K); the height stabilizer (5), with one end connected to the armrest screw (4) and the other end to the spring (7), wherein the height stabilizer (5) passes through the latch channel (11) and enables current height of the armrest (K) to be fixed when position changes of the latch (6) between the first position (I) and the second position (II) are transferred by contacting the inner wall of the latch channel (11). While the pilot pulls the latch (6) towards the mechanism fixing gear (8) to bring the latch (6) to the first position (I), the height stabilizer (5) contacts the inner wall of the latch channel (11) located on the side of the armrest screw (4), thereby changing position of the latch (6) and the armrest screw (4) together. While the pilot pushes the latch (6) towards the armrest screw (4) to bring it to the second position (II), the mechanism stabilizer (9) contacts the inner wall of the latch channel (11) located on the side of the mechanism fixing gear (8), thereby changing position of the latch (6) and the mechanism stabilizer (9) together. When the pilot releases the latch (6) to move it to the third position (III), the height stabilizer (5) and the mechanism fixing gear (8) do not contact with the inner wall of the latch channel (11), thus no position change occurs. Height stabilizer (5) and the mechanism fixing gear (8) move within the latch channel (11) (FIG. 5, FIG. 8, FIG. 9).

In an embodiment of the invention, the armrest locking system (1) comprises at least one height stopper (17) located to form a protrusion on the recess of the armrest screw (4) furthest from the armrest (K); the height stabilizer (5) which has a groove form-compatible with the height stopper (17) at the end thereof contacting the height stopper (17), and allows the height of the armrest (K) to be limited by placing the height stopper (17) in the groove part. In this way, in addition to limiting the height of the armrest (K), the height stopper (17) prevents the armrest (K) from moving out of the armrest arm (15) and/or falling (FIG. 5, FIG. 8).

In an embodiment of the invention, the armrest locking system (1) comprises an angle locker (18) of saddle type, which applies a friction force to the armrest (K) by rotating the armrest (K) around its own axis by a desired amount and compressing the outer wall of the armrest (K), thereby fixing the armrest (K) at its current angle when it is rotated around its own axis. The armrest (K) angle lock is provided by rotating the angle locker (18) around the axis to which it is rotatably attached (FIG. 4).

In an embodiment of the invention, the armrest locking system (1) comprises the armrest (K) with a knurling outer surface on the part in contact with the angle locker (18). The knurling outer surface increases friction and contributes to the armrest (K) angle locking in the position determined by the user (FIG. 4).

In an embodiment of the invention, the armrest locking system (1) comprises the armrest screw (4) in the form of a rachet tooth, which allows one-way height adjustment of the armrest (K) FIG. 5, FIG. 8, FIG. 9).

In an embodiment of the invention, the armrest locking system (1) comprises the body (2), first rotary arm (3), second rotary arm (14) and armrest arm (15) that are rotatably connected to each other using castle nut and cotter pin fasteners. Castle nut and cotter pin is attached to the end parts of the fasteners located on the cylindrical holes at the connection area of the body (2), first rotary arm (3), second rotary arm (14) and armrest arm (15), and ensures their rotatable support (FIG. 4).

1. An armrest locking system (1) comprising a joystick (J) configured to be positioned on an air vehicle and configured to be used by a pilot to steer the air vehicle; at least one armrest (K) configured to be positioned on the air vehicle, and configured for the pilot to place his hand onto, in order to use the joystick (J) in an ergonomic way; a body (2) on the air vehicle; a first rotary arm (3) connected to the body (2) by means of connection type such as a nut and a pin and configured to rotated around by means of a four-bar mechanism about an axis to which it is attached, so as to change a position of the armrest (K); at least one armrest screw (4) located in the form of more than one recesses on the armrest (K) at a distance predetermined by the pilot, thus allowing the height adjustment of the armrest (K), one end of the height stabilizer (5) being seated in a selected recess of the armrest screw (4) while its opposite end is coupled to a spring (7) and guided through a latch channel (11), so that, when the latch (6) is shifted between the first position (I) and the second position (II) and the height stabilizer (5) contacts an inner wall of the latch channel (11), the current height is incrementally set and fixed; at least one height stabilizer (5) which at least partially contacts the armrest screw (4) to fix the armrest (K) at a desired height; a first position (I) in which a distance is provided between the height stabilizer (5) and the armrest screw (4), allowing the height adjustment of the armrest (K); a second position (II) in which the height stabilizer (5) at least partially contacts the armrest screw (4) to fix the height of the armrest (K); a latch (6) that allows the height stabilizer (5) to be moved to the first position (I) or second position (II) by the pilot; at least one spring (7) which is compressed in the first position (I) and the second position (II), and which moves to the second position (II) when the pilot releases the latch (6) in the first position (I), thus enabling the height stabilizer (5) to move from the first position (I) to the second position (II) and fixing the height of the armrest (K), wherein at least one mechanism fixing gear (8) located on the body (2) and having multiple groove-shaped recesses; at least one mechanism stabilizer (9) which removably engages the mechanism fixing gear (8) to fix position of the armrest (K), the mechanism stabilizer (9) being operatively connected to the first rotary arm (3) so that, when it engages the mechanism fixing gear (8), rotation of the first rotary arm (3) relative to the body (2) is prevented and the angular position of the armrest (K) is locked; the first position (I) in which the mechanism stabilizer (9) at least partially contacts the mechanism fixing gear (8) to fix position of the armrest (K); the second position (II) in which a distance is provided between the mechanism stabilizer (9) and the mechanism fixing gear (8) such that position of the armrest (K) is changed freely; the spring (7), with one end connected to the height stabilizer (5) and the other end to the mechanism stabilizer (9); at least one latch plate (10) on which the latch (6) is located; at least one latch channel (11) located as at least two openings on the latch plate (10); the latch (6) that allows the height stabilizer (5) and the mechanism stabilizer (9) to move independently of each other within the latch channel (11), such that the height stabilizer (5) and mechanism stabilizer (9) each move within one latch channel (11) opening and only one of the height stabilizer (5) and the mechanism stabilizer (9) moves together with the latch (6) by contacting an inner wall of the latch channel (11), with the other having a distance to the latch channel (11) opening.

2. An armrest locking system (1) according to claim 1, wherein a third position (III) in which the latch (6) is released in the first position (I) or in the second position (II) such that the height stabilizer (5) at least partially contacts the armrest screw (4) to fix the armrest (K) at a desired height, and in which the mechanism stabilizer (9) at least partially contacts the mechanism fixing gear (8) to fix position of the armrest (K); the spring (7) in compressed state in the first position (I) and the second position (II) that allows the armrest (K) to be moved from the first position (I) or second position (II) to the third position (III) by releasing the latch (6) by the pilot.

3. An armrest locking system (1) according to claim 2, wherein the armrest (K), wherein in the first position (I) the mechanism stabilizer (9) contacts the mechanism fixing gear (8) to fix an end of the spring (7) connected to the mechanism fixing gear (8), in the second position (II) the height stabilizer (5) contacts the armrest screw (4) to fix an end of the spring (7) connected to the height stabilizer (5), in the third position (III) both the mechanism stabilizer (9) contacts the mechanism fixing gear (8) and the height stabilizer (5) is ensured to be locked by contacting the armrest screw (4).

4. An armrest locking system (1) according to claim 1, wherein at least one armrest pin (12) located on the height stabilizer (5) as a protrusion extending perpendicular to the direction along which the height stabilizer (5) extends longitudinally; at least one locking pin (13) located between the spring (7) and the mechanism stabilizer (9) and passing through the latch channel (11), with one end in contact with the spring (7); the latch (6) that allows independent movement at the inner wall of the latch channel (11) due to the armrest pin (12) and locking pin (13) being in contact with the inner walls of the latch channel (11).

5. An armrest locking system (1) according to claim 4, wherein comprising a second rotary arm (14) which is connected to the body (2), rotated around the axis, the second rotary arm (14) cooperating with the body (2), the first rotary arm (3) and an armrest arm (15) to constitute a four-bar linkage; to which it is connected, and forms a four-bar mechanism with the body (2) and the first rotary arm (3); an armrest arm (15) with the armrest (K) thereon, which is connected to the first rotary arm (3) and the second rotary arm (14) and rotates around the axis to which it is connected; at least one transmission arm (16), with one end connected to the mechanism stabilizer (9) and the other end to the locking pin (13), wherein the transmission arm (16) passes through the latch channel (11) and enables position changes of the latch (6) between the first position (I) and the second position (II) to be transferred to the mechanism stabilizer (9) by contacting the inner wall of the latch channel (11) so that displacement of the latch (6) between the first position (I) and the second position (II) and contact of the transmission arm (16) with an inner wall of the latch channel (11) transmits the resulting motion to the mechanism stabilizer (9) to lock or release the position of the armrest (K).

6. An armrest locking system (1) according to claim 1, wherein the latch channel (11) telescopically connected to height stabilizer (5) and mechanism stabilizer (9).

7. An armrest locking system (1) according to claim 5, wherein the mechanism fixing gear (8) in a gear form with successive recesses and protrusions, which is located at an end of the second rotary arm (14) connected to the armrest arm (15), so as to surround the end of the second rotary arm (14) connected to the armrest arm (15).

8. An armrest locking system (1) according to claim 5, wherein the armrest screw (4) with groove-shaped recesses, which is located at intervals determined by the pilot, from the end of the armrest (K) connected to the armrest arm (15), towards the armrest (K), wherein the armrest screw (4) allows height adjustment of the armrest (K); the height stabilizer (5), with one end connected to the armrest screw (4) and the other end to the spring (7), wherein the height stabilizer (5) passes through the latch channel (11) and enables current height of the armrest (K) to be fixed when position changes of the latch (6) between the first position (I) and the second position (II) are transferred by contacting the inner wall of the latch channel (11).

9. An armrest locking system (1) according to claim 1, wherein at least one height stopper (17) located to form a protrusion on the recess of the armrest screw (4) furthest from the armrest (K); the height stabilizer (5) which has a groove form-compatible with the height stopper (17) at the end thereof contacting the height stopper (17), and allows the height of the armrest (K) to be limited by placing the height stopper (17) in the groove part.

10. An armrest locking system (1) according to claim 1, wherein an angle locker (18) of saddle type, which compressing the outer wall of the armrest (K), fixing the armrest (K) at its current angle.

11. An armrest locking system (1) according to claim 10, wherein the armrest (K) comprises a knurling outer surface on the part that is in contact with the angle locker (18).

12. An armrest locking system (1) according to claim 1, wherein the armrest screw (4) in the form of a rachet tooth, which allows one-way height adjustment of the armrest (K).

13. An armrest locking system (1) according to claim 5, wherein the body (2), first rotary arm (3), second rotary arm (14) and armrest arm (15) that are rotatably connected to each other using castle nut and cotter pin fasteners.
